(19) United States
(12) Patent Application Publication
(10) Pub. No.: US 2004/0247973 A1
(43) Pub. Date: Dec. 9, 2004

(54) Methods of manufacture of electrolyte tubes for solid oxide devices and the devices obtained therefrom

(76) Inventors: Nigel Mark Sammes, Lincoln, RI (US); Yanhai Du, Storrs, CT (US)

Correspondence Address: CANTOR COLBURN LLP, 55 Griffin Road South, Bloomfield, CT, 06002, US

(21) Appl. No.: 10/811,484

(22) Filed: Mar. 26, 2004

Related U.S. Application Data
(60) Provisional application No. 60/458,280, filed on Mar. 27, 2003.

(51) Int. Cl. H01M 8/12; B28B 3/20

(52) U.S. Cl. 429/31; 264/634; 264/618; 264/638

(57) ABSTRACT

A method of manufacturing a green electrolyte tube comprises forming a composition comprising lanthanum-strontium-gallium-magnesium oxide powder, a binder, a lubricant, a solvent and a pH control agent into a green electrolyte tube, wherein the outer diameter of the green electrolyte tube has a tolerance of less than or equal to about ±0.3 millimeters over a tube length of greater than or equal to about 5 millimeters, and the wall thickness of the green electrolyte tube has a tolerance of less than or equal to about ±0.2 millimeters over a length of greater than or equal to about 5 millimeters.

### CROSS REFERENCE TO RELATED APPLICATIONS

This application claims the benefit of U.S. Provisional Application Ser. No. 60/458,280, filed Mar. 27, 2003.

### BACKGROUND

The present disclosure is related to methods of manufacture of electrolyte tubes for solid oxide devices and the devices obtained therefrom.

Solid oxide devices such as fuel cells, oxygen pumps, sensors, and the like, generally offer opportunities for an efficient conversion of chemical energy to electric power with minimal pollution. Solid oxide fuel cells are considered to be especially promising for the generation of electricity. Solid oxide devices generally contain an electrolyte made from zirconia-based materials such as yttria stabilized zirconia (YSZ) which operate at elevated temperatures of over about 800 to about 1000° C. In order for these devices to function usefully and efficiently at these temperatures it is desirable that the structural materials used in these solid oxide devices be stable in the oxidizing atmosphere generated at the cathode and the reducing atmosphere generated at the anode. This is generally achieved by using high temperature alloys as structural materials. However, while these structural materials are stable at the elevated operating temperatures, they are also unfortunately expensive. In order to enable the use of less expensive structural materials, efforts have been made in recent years to lower the operating temperature to about 600 to about 800° C.

These efforts have led to the development of a new class of electrolytic materials called lanthanum-strontium-gallium-magnesium oxide (LSGM) powders having a perovskite structure. These powders can operate in solid oxide devices at intermediate temperatures of about 600 to about 800° C., but also have a number of drawbacks. They are not easily fabricated into large monolithic elongated shapes such as tubes, cylinders, and the like. Further these LSGM powders do not retain their dimensions when subjected to sintering. There is therefore a need for methods of fabricating these materials into tubular shapes, which can retain their geometry and dimensions after sintering and which can also further function efficiently in solid oxide devices.

### BRIEF SUMMARY

In one embodiment, a method of manufacturing a green electrolyte tube comprises forming a composition comprising lanthanum-strontium-gallium-magnesium oxide powder, a binder, a lubricant, a solvent and a pH control agent into a green electrolyte tube, wherein the outer diameter of the green electrolyte tube has a tolerance of less than or equal to about ±0.3 millimeters over a tube length of greater than or equal to about 5 millimeters, and the wall thickness of the green electrolyte tube has a tolerance of less than or equal to about ±0.2 millimeters over a length of greater than or equal to about 5 millimeters.

In another embodiment, a solid oxide device comprises the green extruded electrolyte tube.

In yet another embodiment, a method of manufacturing a solid oxide fuel cell comprises extruding a composition comprising lanthanum-strontium-gallium-magnesium oxide powder, a binder, a lubricant, a solvent and a pH control agent into a green electrolyte tube; sintering the green electrolyte tube to form a sintered electrolyte tube, wherein the outer diameter of the sintered electrolyte tube has a tolerance of less than or equal to about ±0.3 millimeter over a tube length of greater than or equal to about 5 millimeters and wall thickness of the sintered electrolyte tube has a tolerance of less than or equal to about ±0.2 millimeter over a tube length of greater than or equal to about 5 millimeters; and disposing upon the sintered electrolyte an anode and a cathode.

In yet another embodiment, a solid oxide device comprises a sintered electrolyte tube.

### DESCRIPTION OF FIGURES

FIG. 1 represents a cross-sectional view of a tube holder containing an extruded electrolyte tube during drying;

FIG. 2 depicts a) a V-shaped sample holder and b) a semi-cylindrical sample holder, which are used to hold extruded tubes during the process of sintering;

FIG. 3 is a picture of the furnace test station used for determining performance of solid oxide fuel cells;

FIG. 4 is a linear plot of voltage (V) and power density in milliwatts/square centimeter (mW/cm²) versus current density in amperes/square centimeter (A/cm²) for a fuel cell having the composition of Sample 2 of Table 2. The tests were measured over a period of 30 minutes to 48 hours;

FIG. 5 is a bar graph depicting the maximum power density of the solid oxide fuel cells at temperatures of 600, 650, 700, 750, 800 and 850° C. respectively;

FIG. 6 is a linear plot depicting solid oxide fuel cell performance stability over time, at a loading of 0.7 V and for temperatures of 800 and 850° C. respectively for Sample 2 of Table 2;

FIG. 7 is a linear plot illustrating the effect of time and temperature of cell operation on the cell performance for Sample 2 of Table 2. Power was measured at temperatures of 700, 750, 800 and 850° C. respectively;

FIG. 8 is a bar graph depicting the power density performance of Sample 2 and Sample 5 respectively from Table 2 at temperatures of 700, 750, and 800° C. respectively; and

FIG. 9 is a linear plot of the power density performance at different electrolyte wall thicknesses for Sample 2 of Table 2 at temperatures of 700, 750, and 800° C. respectively.

### DETAILED DESCRIPTION OF PREFERRED EMBODIMENTS

Disclosed herein is a method for obtaining a sintered electrolyte tube by an extrusion process. The electrolyte tube thus obtained may be used to form a solid oxide device such as, for example, a fuel cell, an oxygen pump, or a sensor by applying an anode and a cathode to its surfaces. The sintered electrolyte tube generally comprises a lanthanum-strontium-gallium-magnesium oxide (LSGM) having a perovskite structure and can advantageously retain its cylindrical features such as its straightness, its circumferential dimensions and its wall thickness through several sintering cycles prior to and following the application of the anode and the cathode. The sintered electrolyte tube thus obtained may have a wall thickness of less than or equal to about 1000 micrometers which permits a higher maximum power density than electrolyte tubes having thicker walls. It can also advantageously operate within fuel cells at temperatures of about 600 to about 800° C. thereby reducing structural and operating costs.

In one embodiment, the sintered electrolyte tube is an LSGM expressed as in the formula (I) below:

La₁₋ₐAₐGa_{1-b}B_{b}O_{3-c} (I)

wherein La represents lanthanum, A is strontium or calcium, Ga is gallium, B is magnesium, aluminum or indium and O is oxygen and wherein 0.05≦a≦0.3, 0≦b≦0.3, and c=(a+b)/2 (0≦c≦0.15, b+c≦0.3 and 0≦d≦1). In another embodiment, the LSGM has three or more crystal phases each having a different composition. The language “crystal phases having a different composition” as used herein is intended to mean crystal phases containing the same or different kinds of constituent elements but wherein the molar ratio of the different elements contained in the different crystal phases is different. For example, when one crystal phase contains lanthanum, gallium and three other elements in a molar ratio of a:b:c:d:e, the molar ratio of the same elements in another crystal phase may be a:b′:c′:d′:e, a′:b′:c′:d′:e′, and the like, provided that a≠a′, b≠b′, c≠c′, d≠d′, and e≠e′.

It is generally desirable for the sintered electrolyte tube to have a first crystal phase close to the stoichiometric ratio of LaGaO₃ (i.e., La:Ga:O=1:1:3), and a second crystal phase whose composition is different from the stoichiometric ratio of the elements contained in the first crystal phase. It is also generally desirable for the sintered electrolyte tube to have an additional crystal phase which is different in composition from either the first or the second crystal phase. This additional crystal phase is usually a grain boundary phase and is hereinafter referred to as the third crystal phase.

The sintered electrolyte tube having the above-described structure (i.e., three different crystal phases) is generally formed by incorporation of aluminum. The aluminum content in the sintered body is generally expressed as the ratio of the molar quantity of aluminum to the sum of the molar quantities of lanthanum, gallium and oxygen. In order to have the three different crystal phases it is generally desirable to have the molar ratio of aluminum to the sum of lanthanum, gallium and oxygen from about 0.05 to about 0.5. Within this range, it is desirable to have the molar ratio less than or equal to about 0.2, preferably less than or equal to about 0.1. The preferred LSGM is La_{0.8}Sr_{0.2}Ga_{0.8}Mg_{0.2}O_{2.8}.

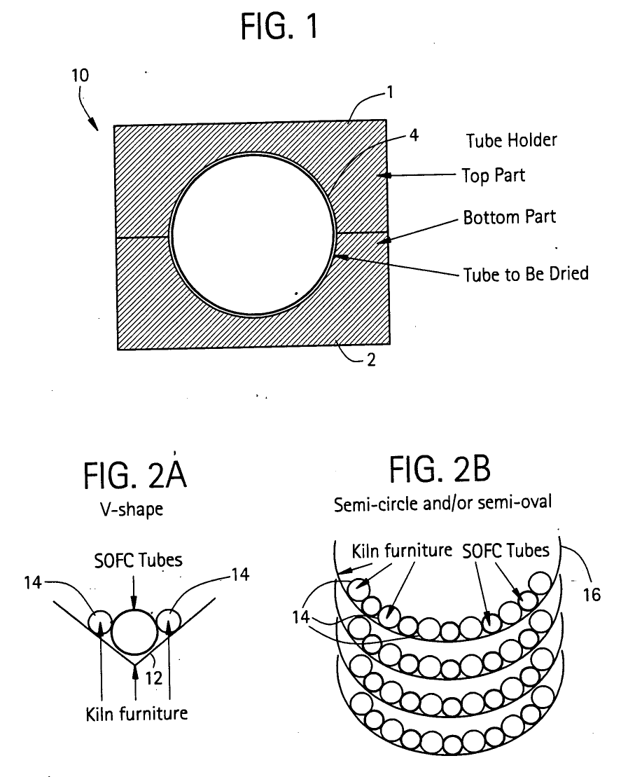

The sintered electrolyte tube is generally prepared by mixing together the requisite ceramic powders having the composition of the LSGM or from which the LSGM may be derived, with a binder, a surfactant, a lubricant, a pH control agent, and distilled water to form a dough. The dough is then extruded into tubes using an extruder through an extrusion die to form the green electrolyte tube. The green electrolyte tubes are dried at room temperature in air and in specially designed tube holders as shown in FIG. 1. Following drying, the green electrolyte tubes are subjected to sintering in an electrical furnace during which the powdered particles in the tube are fused together to form the sintered electrolyte tube. Following sintering, the sintered electrolyte tube is coated with respective anode, cathode and interlayer slurries and re-sintered to form an anode, a cathode and an interlayer respectively.

Ceramic powders utilized to form the sintered electrolyte tube are generally oxides and/or salts such as carbonates, sulfates, nitrates, and chlorides of metals such as lanthanum, strontium, gallium and magnesium. The oxides and/or salts of lanthanum, strontium, gallium and magnesium are mixed in the correct stoichiometric ratio prior to sintering under pressure to form an LSGM having a perovskite structure. The LSGM is then ground prior to extrusion into an electrolyte tube. Additional ceramic powders such as oxides and salts of aluminum, calcium and indium may also be utilized in the LSGM if desired. The preferred ceramic powders are lanthanum oxide (La₂O₃), gallium oxide (Ga₂O₃), magnesium oxide (MgO) and strontium carbonate (SrCO₃).

It is generally desirable to add the lanthanum oxide in an amount of about 55 wt % to about 60 wt %, based on the total weight of the ceramic powders utilized to form the LSGM. Similarly it is desirable to add the gallium oxide in an amount of about 30 wt % to about 35 wt %, magnesium oxide in an amount of about 1.5 wt % to about 4.5 wt %, and strontium carbonate in an amount of about 6.0 wt % to about 13.0 wt %, based on the total weight of the ceramic powders utilized to form the LSGM. The ceramic powders generally have an average size of less than or equal to about micrometers.

Alternatively, the sintered electrolyte tube may be obtained by using commercially available LSGM powders. Suitable examples of such powders are La_{0.8}Sr_{0.2}Ga_{0.8}Mg_{0.2}O_{2.8}. The LSGM powders are generally used in amounts of about 60 weight percent (wt %) to about 95 wt % based on the total weight of the dough. Within this range it is generally desirable to use the ceramic powder in an amount of greater than or equal to about 70 wt %, preferably greater than or equal to about 75 wt %, and more preferably greater than or equal to about 80 wt %. Within this range it is also generally desirable to use the ceramic powder in an amount of less than or equal to about 93 wt %, preferably less than or equal to about 91 wt %, and more preferably less than or equal to about 90 wt %.

Lubricants are generally used to lower the viscosity of the dough and to facilitate the extrusion process. Preferred lubricants are generally alkylene glycols. Alkylene glycols suitable for use in the dough include, for example, ethylene glycol, 1,2-propylene glycol, 1,3-propylene glycol, glycerol, 1,3-butylene glycol, 1,4-butylene glycol, 2,3-butylene glycol, 1,5-pentanediol, 1,6-hexanediol, 1,8-octanediol, 1,9-nonanediol, 1,10-decanediol, neopentyl glycol, 1,4-cyclohexanedimethanol, 2-methyl-1,3-propanediol, 2,2,4-trimethyl-1,3-pentanediol, diethylene glycol, dipropylene glycol, triethylene glycol, tripropylene glycol, dibutylene glycol, polyethylene glycol, polypropylene glycol, polytetramethylene glycol, and the like, and combinations thereof. The preferred lubricant is polyethylene glycol commercially available from the Dow Chemical Company as Carbowax™ or Carbowax Sentry™ having a molecular weight of about 400 grams/mole (g/mole).

The alkylene glycols generally have a molecular weight of about 100 to about 300,000 grams/mole (g/mole). Within this range, it is desirable to use alkylene glycols having a molecular weight greater than or equal to about 200 g/mole, preferably greater than or equal to about 300 g/mole, and more preferably greater than or equal to about 350 g/mole. It is also desirable to use alkylene glycols having a molecular weight less than or equal to about 250,000 g/mole, preferably less than or equal to about 200,000 g/mole, and more preferably less than or equal to about 150,000 g/mole.

The alkylene glycols are generally added in amounts of about 0.5 wt % to about 2.5 wt % based on the total weight of the composition. Within this range it is generally desirable to use the alkylene glycols in an amount of greater than or equal to about 0.7 wt %, preferably greater than or equal to about 0.8 wt %, and more preferably greater than or equal to about 0.9 wt %. Within this range it is generally desirable to use the alkylene glycols an amount of less than or equal to about 2.2 wt %, preferably less than or equal to about 2.0 wt %, and more preferably less than or equal to about 1.8 wt %.

The pH control agents are added for purposes of controlling agglomeration and forming a uniform mix of the powder particles during mixing. In order to control the agglomeration and to form uniform dough of the particles during the mixing, the pH of the dough is adjusted to be about 9 to about 11. The pH control agents may be either acidic, basic or combinations thereof as desired. Suitable, but non-limiting examples of pH control agents are caustic soda, lime, quicklime, soda ash, ethyl amine, 2-amino-2-methyl-1-propanol, hydrochloric acid, acetic acid, toluene sulfonic acid, and the like. The preferred pH control additive is 2-amino-2-methyl-1-propanol commercially available from Angus Chemical as AMP-95.

The pH control agents are generally added in amounts of about 0.5 wt % to about 3.5 wt % based on the total weight of the composition. Within this range, it is generally desirable to use the pH control agents in an amount of greater than or equal to about 0.8 wt %, preferably greater than or equal to about 1 wt %, and more preferably greater than or equal to about 1.2 wt %. Within this range, it is generally desirable to use the pH control agents in an amount of less than or equal to about 3.2 wt %, preferably less than or equal to about 3 wt %, and more preferably less than or equal to about 2.8 wt %.

A binder is generally added for purposes of providing strength to the green extrudate. The binder preferably is an emulsion comprising an insoluble polymer gel dispersed in water. Examples of polymers used in the binder are acrylic based polymers, polyethers, or the like, or combinations comprising at least one of the foregoing polymers. The binder preferably comprises about 20 to about 70 wt % of the insoluble polymer gel based on the total weight of the binder. Within this range, it is generally desirable to have an amount of greater than or equal to about 22, preferably greater than or equal to about 24, and more preferably greater than or equal to about 26 wt % of the insoluble polymer gel based on the total weight of the binder. Within this range, it is generally desirable to have an amount of less than or equal to about 68, preferably less than or equal to about 65, and more preferably less than or equal to about 62 wt % of the polymer gel based on the total weight of the binder.

The binder is generally added in amounts of about 8 wt % to about 25 wt % based on the total weight of the composition. Within this range, it is generally desirable to use the binder in an amount of greater than or equal to about 9 wt %, preferably greater than or equal to about 10 wt %, and more preferably greater than or equal to about 10.5 wt %. Within this range, it is generally desirable to use the binder in an amount of less than or equal to about 24 wt %, preferably less than or equal to about 23 wt %, and more preferably less than or equal to about 21 wt %. The preferred binder is B1051 and B1052 commercially available from Duramax.

Distilled water is also used to wet the particles and to enhance the ability of the binder to bind the ceramic particles in a manner such as to prevent agglomeration. Distilled water may be added to the dough in an amount of about 1 wt % to about 10 wt % based on the total weight of the composition. Within this range, it is generally desirable to use the distilled water in an amount of greater than or equal to about 1.5 wt %, preferably greater than or equal to about 2 wt %, and more preferably greater than or equal to about 2.5 wt %. Within this range, it is generally desirable to use the distilled water in an amount of less than or equal to about 9.5 wt %, preferably less than or equal to about 9 wt %, and more preferably less than or equal to about 8.5 wt %.

Other components such as, for example, surfactants, solvents, fillers, fibers, and the like, may optionally be added to the dough. The components such as the ceramic powder, binder, lubricant and the distilled water along with other optional components may be mixed in a mixing device such as, for example, a sigma blade mixer, a helicone, a roll mill, a Ross mixer, a dough mixer, a Waring blender, a Henschel, screw extruder, twin screw extruder, buss kneader or combinations comprising at least one of the foregoing mixing devices in order to form the dough. The preferred mixing device is a sigma blade mixer. Mixing is generally carried out at a temperature of about 8° C. to about 50° C. The preferred temperature is room temperature. During the mixing, a vacuum may be applied to the mixer if desired in order to remove excess water or solvent, if desired. The vacuum may be applied in an amount of about 5 millimeters of mercury (Hg) to about 700 millimeters of Hg. The preferred vacuum is about 28 millimeters of Hg. The dough is generally mixed for a time period of about 5 minutes to about 180 minutes. The preferred mixing time is about 60 minutes. The energy input during the mixing is about 0.5 to about 2 kilowatt-hour/kilogram of dough. The preferred energy input is 1 kilowatt-hour/kilogram.

The dough generally has a rheology-shear stress of up to 1 mega Pascals (MPa) at shear rate of about 10 to about 500 seconds⁻¹ at room temperature. The dough preferably has a rheology-shear stress of less than or equal to about 0.8 MPa, more preferably less than or equal to about 0.6 MPa, and most preferably less than or equal to about 0.4 MPa at a shear rate of about 10 to about 500 seconds⁻¹ at room temperature.

The dough may then be subjected to extrusion in a single screw extruder, twin screw extruder, buss kneader, ram extruder or combinations comprising the foregoing extruders in order to form the extruded electrolyte tube. Alternatively, the dough may be injection molded, compression molded, blow molded, vacuum formed in order to obtain the electrolyte tube. The extrusion is generally carried out at a temperature of about 10° C. to about 50° C. and a pressure of about 1 ton/inch² to about 10 ton/inch². The preferred extrusion temperature is about 25° C. The energy used during the extrusion is about 1 to about 3 kilowatt-hour/kilogram (kwhr/kg). The preferred energy used is 1.7 kwhr/kg.

The green extruded electrolyte tubes generally have lengths greater than or equal to about 0.05 meters, preferably greater than or equal to about 0.2 meters and outer diameters of about 2 millimeters to about 10 millimeters, with an extruded outer diameter of about 4 millimeters to about 6 millimeters preferred. Variations in the dimension of the outer diameter are less than or equal to about ±0.3 millimeters, preferably less than or equal to about ±0.2 millimeter, and more preferably less than or equal to about ±0.15 millimeter, over a length of greater than or equal to about 5 millimeters. The variation in diameter or wall thickness is termed a ‘tolerance’. The wall thickness of the green extruded electrolyte tube is generally about 0.1 millimeters to about 1 millimeter, with a wall thickness of about 0.2 millimeters to about 0.6 millimeters generally preferred. Variations in the wall thickness of the green extruded electrolyte tube is generally less than or equal to about ±0.2 millimeters during production, preferably less than or equal to about ±0.15 millimeters, and more preferably less than or equal to about ±0.1 millimeters, over a length of greater than or equal to about 5 millimeters.

As stated above, the extruded electrolyte tube is then subjected to drying at room temperature in air or in moving air in in-house designed tube holders for a time period of about 2 hours to about 10 hours, with a preferred drying time of about 5 hours as shown in FIG. 1. In the FIG. 1, the in-house tube holder 10 may be seen to comprise two blocks 1 and 2 respectively. Each block has a hollow semi-cylinder cut out of it such that when the two halves are put together as shown in FIG. 1, a hollow cylindrical tube 3 capable of supporting the electrolyte tube is formed. The green extruded electrolyte tube is then placed into the in-house designed tube holder to dry in air or in moving air if desired. The moving air may generally have a velocity of about 20 millimeters per second to about 2000 millimeters per second. It is generally desirable for the inner diameter of the cylindrical tube 3 formed within the blocks 1 and 2 to be greater than or equal to the outer diameter of the green extruded electrolyte tube.

The dried electrolyte tube is then subjected to sintering in an electrical furnace at 1350° C. to about 1600° C. for a time period of about 2 to about 12 hours. The preferred sintering temperature is 1500° C. and the preferred time period is about 6 hours. The sintering is generally conducted by placing the green extruded electrolyte tube holders in a V shaped, semi-cylindrical shaped or semi-elliptical shaped sample holder. On embodiment of a V shaped sample holder is shown in FIG. 2a, while an embodiment of a semi-cylindrical shaped or semi-elliptical shaped sample holder is shown in FIG. 2b respectively. As may be seen in FIG. 2a, the V shaped sample holder 12 contains kiln furniture 14 in the form of tubes, which support the green extruded electrolyte tube during sintering. Similarly in FIG. 2b, the semi-cylindrical sample holder 16 contains kiln furniture 14 in the form of tubes, which support the green extruded electrolyte tube. It is preferable for each green extruded electrolyte tube to be supported between two tubes, one on either side, during the process of sintering. This method of sintering permits the electrolyte tube to maintain its cylindrical shape during sintering.

The sintered electrolyte tube generally has lengths greater than or equal to about 0.05 meters, preferably greater than or equal to about 0.1 meters and outer diameters of about 1.8 millimeters to about 9 millimeters, with an outer diameter of about 3.8 millimeters to about 5.5 millimeters preferred. Variations in the dimension of the outer diameter are less than or equal to about ±0.3 millimeters, preferably less than or equal to about ±0.2 millimeter, and more preferably less than or equal to about ±0.1 millimeter over a length of greater than or equal to about 5 millimeters. The wall thickness of the sintered electrolyte tube is generally about 0.1 millimeters to about 0.9 millimeters, with a wall thickness of about 0.2 millimeters to about 0.5 millimeters generally preferred. Variations in the wall thickness of the sintered electrolyte tube is generally less than or equal to about ±0.2 millimeters during production, preferably less than or equal to about ±0.1 millimeters, and more preferably less than or equal to about ±0.05 millimeters over a length of greater than or equal to about 5 millimeters.

The sintered electrolyte tube can then be used to form a single tubular solid oxide fuel cell by applying an anode, cathode and the associated current collectors to the sintered electrolyte tube. The anode, cathode and optionally an interlayer are generally applied to the sintered electrolyte tube in the form of a slurry by a number of different methods such as for example, dip coating, dip coating using a syringe-pipe configuration, chemical vapor deposition, spray painting, electrostatic painting, painting with a brush or combinations of one of the foregoing methods. The preferred methods of applying the slurries are dip coating using a syringe-pipe configuration and painting with a brush. The respective slurries may be applied to both surfaces of the tube in a manner such that if the anode is applied to the inner surface, the cathode is applied to the outer surface and vice-versa.

It is generally desirable to dip coat the inner surfaces of the sintered electrolyte tube using the syringe-pipe configuration. In this configuration, a slurry of choice is coated onto the inside of the sintered electrolyte tube by using a syringe. This method is advantageous in that it permits the inside of the electrolyte tube to be coated with the appropriate slurry while preventing the outer surface from being contaminated with the slurry materials used to coat the inside surface. For example, if the inner surface is to be coated with the anode slurry, which is subsequently sintered to form the anode, the outer surface upon which the cathode will be coated will not be contaminated with the anode slurry.

In the preparation of the anode, cathode or interlayer slurries, the respective ceramic powders are first ball milled in solvents such as, but not limited to, an ethanol-methyl ethyl ketone solution containing polymers such as, but not limited to, polyvinylpyrollidinone (PVP) having a molecular weight of 72.11 g/mole. In general the weight ratio of ethanol to methyl ethyl ketone is from 1:3 to about 1:1, with a weight ratio of about 2:3 being preferred. Similarly, the weight ratio of PVP to the total weight of ethanol and methyl ethyl ketone is about 1:6 to about 2:1, with a weight ratio of 5:6 being preferred. The ball milling is generally continued for a time period effective to reduce the average particle sizes (diameters) in either of the anode, cathode or the interlayer slurries to less than about 2 micrometers. The preferred average particle diameters in the slurry are less than about 1 micrometer. It is generally desirable to have at least 50% of the particles less than or equal to about 1 micrometer in diameter.

The interlayer if desired is generally first applied to the sintered electrolyte tube in the form of a slurry by dip coating using the syringe-pipe configuration. It can be applied to the inside or the outside of the sintered electrolyte tube and is derived from the sintering of samarium doped cerium (SDC). It is generally applied between the sintered electrolyte tube and the anode to eliminate reactions during the sintering process between the nickel from the anode and the lanthanum contained in the electrolyte tube. The reaction between the lanthanum and nickel yields a resistive layer of lanthanum nickel oxide (LaNiO₃). After the application of the interlayer slurry, the electrolyte sintered tube is again sintered at a temperature of about 1200 to about 1400° C. for a time period of about 15 to about 60 minutes. The preferred temperature for sintering is about 1350° C. and the preferred time for sintering of the interlayer is about 30 minutes. The interlayer has a thickness of about 10 to about 15 micrometers.

The anode is generally formed by dip coating the sintered electrolyte tube containing the optional interlayer in an anode slurry comprising ceramic powders such as, for example, nickel oxide (NiO), cobalt oxide (CoO or Co₃O₄), nickel oxide with yttrium stabilized zirconia (Ni+8YSZ), nickel oxide with samarium doped ceria (SDC20+Ni) or combinations comprising at least one of the foregoing ceramic powders. The anode is generally formed by sintering the anode slurry coated onto the electrolyte tube at temperatures of about 800 to about 1300° C., for time periods of about 20 to about 180 minutes. The nickel oxides are reduced to nickel or the cobalt oxides are reduced to cobalt at reducing atmosphere, like fuel environment at elevated temperature to perform anode functions. The anode after sintering generally has a thickness of about 10 to about 30 micrometers. Within this range, it is generally desirable to have a thickness greater than or equal to about 12, preferably greater than or equal to about 14, and most preferably greater than or equal to about 15 micrometers. It is also desirable to have a thickness of less than or equal to about 25, preferably less than or equal to about 22, and more preferably less than or equal to about 20 micrometers.

The cathode slurry is generally applied to the electrolyte tube either prior to the formation of the anode, during the formation of the anode or after the formation of the anode and is generally brush painted on. It is preferable to apply the cathode slurry after the anode has been formed on the sintered electrolyte tube. The cathode is generally derived by the sintering of powders such as, for example, lanthanum-samarium-cobalt (LSCo), samarium-strontium-cobalt (SmSrCo), samarium-strontium-cobalt oxide (SmSrCoO₃) or combinations comprising at least one of the foregoing ceramic powders. The electrolyte tube containing the cobalt slurry is sintered at temperatures of about 800° C. to about 1200° C. for a time period of about 15 to about 150 minutes. The preferred sintering temperatures for cathodes derived from LSCo or SmSrCo is about 1100° C. and the preferred time is about 2 hours, while for cathodes derived from SmSrCoO₃, the preferred temperature is about 900° C. and the preferred time period is about 0.5 hours. The cathode generally has a thickness of about 20 to about 30 micrometers.

After the formation of the anode, cathode and the optional interlayer, the respective current collectors may be applied to the electrodes to form a solid oxide fuel cell. For example, a silver wire cathode current collector is tightly wound onto the outside of the tubes after the cathode is sintered. Similarly a nickel mesh is applied to the anode as the anode current collector to complete the formation of the solid oxide fuel cells.

Solid oxide fuel cells derived from the sintered electrolyte tube generally have a power density greater than or equal to about 0.25 watts/square centimeter (W/cm²) and an ionic transference number close to unity. As defined herein, the ionic transference number is given by the ratio of the ionic conductivity to the total conductivity, wherein the total conductivity is the sum of the electronic and ionic conductivity. The solid oxide fuel cells obtained from the sintered electrolyte tubes in this manner can have reduced wall thickness of about 0.2 millimeters. These reduced wall thickness permit higher power densities especially when compared with fuel cells having larger wall thickness greater than or equal to about 0.5 millimeter. This method of extruding the electrolyte tube increases the manufacturing yield of electrolyte tubes, decreases the capital investment required for equipment, decreases the manufacturing cycle time, and increases the throughput of the manufacturing facility thereby reducing the cost of producing solid oxide fuel cells for solid oxide fuel cell generators.

The following examples, which are meant to be exemplary, not limiting, illustrate compositions and methods of manufacturing some of the various embodiments of the sintered electrolyte tubes described herein and the solid oxide fuel cells derived therefrom.

### EXAMPLE 1

In this example, electrolyte tubes were fabricated using commercial LSGM powder having the formulation La_{0.8}Sr_{0.2}Ga_{0.8}Mg_{0.2}O_{2.8} obtained from Praxair Inc. The LSGM powder was mixed with polyethylene glycol (having a molecular weight of 400 g/mole) lubricant commercially available from Dow Chemical, pH control agent 2-amino-2-methyl-1-propanol commercially available as AMP-95 from Angus Chemical, binder B1051/B1052 commerically available from Duramax, and distilled water, in a sigma blade mixer commercially available from Jaygo Incorporated. The weight percents of the respective components of this formulation are shown in Table 1 below.

TABLE 1

| Components | Weight Percent |
|---|---|
| LSGM | 85.7 |
| B1051 | 8.5 |
| B1052 | 1.7 |
| PEG-400 | 1.3 |
| AMP-95 | 2.1 |
| Distilled Water | 1.7 |

The mixing was carried on for 1 hour to permit the mixture to form a dough. A vacuum of 28 millimeters mercury (Hg) was then applied during the mixing for 10 minutes to degass the dough. The dough generally has a pH of about 10 and a moisture content of about 12 wt %. The dough was left to age and homogenize for a time period of about 4 to about 24 hours prior to being subject to extrusion.

The dough was then extruded into the electrolyte tubes using a 16 ton (T) ram extruder manufactured by Loomis Products Company. The applied ram pressure was 2.5 tons/square inch. The extruded electrolyte tubes were then dried in air in custom designed tube holders as shown in FIG. 1. The dried electrolyte tubes were then sintered in an electrical furnace at 1500° C. for 6 hours in air using kiln furniture (i.e., sample holders) having a V shape or semi-cylindrical shape as shown in FIG. 2. The use of the V-shaped and semi-cylindrical kiln furniture configuration during the sintering process permits the sintered tubes to maintain their shapes and distortion, without significant distortion. Two different size tubes were fabricated in order to study the effect of wall thickness on the solid oxide fuel cell electrical and mechanical properties. The dimensions of the tubes after sintering were (a) 6 millimeter outside diameter, 0.55 millimeter wall thickness and about 100 to about 200 millimeters long and (b) 4 millimeter outside diameter, 0.22 millimeter wall thickness and about 50 to about 100 millimeters long.

Following sintering of the electrolyte tubes; anodes, cathodes and optionally an interlayer were applied to the tubes to form the solid oxide fuel cell. Six solid oxide fuel cell configurations are shown in Table 2 below.

TABLE 2

| Sample# | Cathode | Electrolyte | Interlayer | Anode |
|---|---|---|---|---|
| 1 | ¹LSCo | LSGM | — | Ni |
| 2 | ¹LSCo | LSGM | ⁴SDC | Ni |
| 3 | ¹LSCo | LSGM | ⁴SDC | SDC + Ni |
| 4 | ²SₘSᵣCo | LSGM | ⁴SDC | Ni |
| 5 | ¹LSCo | LSGM | — | Co |
| 6 | ³LSM | LSGM | ⁴SDC | Ni + 8YSZ |

¹LSCo is derived by the sintering of La_{0.6}Sr_{0.4}CoO₃.
²SₘSᵣCo is derived by the sintering of Sm_{0.5}Sr_{0.5}CoO₃.
³LSM is derived by the sintering of La_{0.8}Sr_{0.2}MnO₃.
⁴SDC is derived by the sintering of Ce_{0.8}Sm_{0.2}O_{1.9}.

The anode, cathode, and the interlayer were first made into slurries in order to apply onto the sintered electrolyte tubes. In order to apply the anode, cathode and the interlayer, the respective ceramic powders shown in Table 2 above, were ball milled into a slurry in an ethanol-methyl ethyl ketone solution containing polyvinylpyrollidinone (PVP) binder until the average particle size was less than 1 micrometer. The anode slurry was then dip coated on the inside of the sintered electrolyte tubes by sucking the slurry up into the tubes using a syringe-pipe configuration. The anode slurry was generally sintered at a temperature of 1200° C. for 2 hours to form the anode, except for the cobalt oxide (Co₃O₄) based anode slurry of sample 5 that was sintered at 900° C. for 0.5 hours. The anode had a thickness of 15 to 20 micrometers. When an interlayer was used as in Samples 2, 3, 4 and 6, it was applied in the form of a slurry in the same manner as the anode but was sintered at a temperature of about 1350° C. for about 30 minutes. The sintered interlayer had a thickness of about 10 to about 15 micrometers. The cathode slurry was brush painted onto the outer surface of the electrolyte tubes after the application of the interlayer and the anode. The cathode slurries were generally sintered at temperatures of 1100° C. for 2 hours, except for sample 4 which contained Sm_{0.5}Sr_{0.5}CoO₃, and was sintered at a temperature of 900° C. for 0.5 hours. The cathode had a thickness of about 20 to about 30 micrometers.

The cathode current collector comprising 99.9% silver wire commercially available from Silver State Wire Co, was tightly wound onto the outside of the tubes after the sintering of the anode and cathode slurries to form the respective layers. A nickel mesh commercially available from Alfa Aesar was used as the anode current collector to complete the circuit for the formation of a single solid oxide fuel cell. The effective dimensions of the solid oxide fuel cells prepared were: (a) outer diameter of 6 millimeters, wall thickness of 0.55 millimeter, active length of 50 millimeters; (b) outer diameter of 4 millimeters, wall thickness of 0.22 millimeters, active length of 30 millimeters.

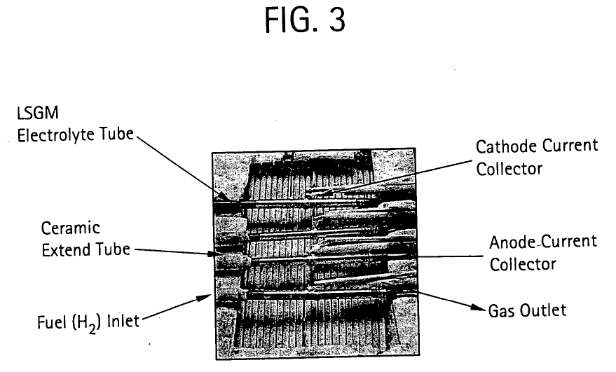

The electrical performances of the fuel cells were tested using a furnace test station setup shown in FIG. 3. Dry hydrogen was fed to the inside of the tubular cell at 50 milliliters/minute (ml/min), and air was used as the oxidant gas. Current-voltage (I-V) data was collected using a potentiostat/galvanostat in the temperature range of 600° C. to 850° C. at 50° C. intervals. Up to four cells of each composition were tested at the same time. If for example, four cells of Sample 2 from Table 1 were tested at the same time, then the cells were labeled 2A, 2B, 2C and 2D respectively. Current density and power density were then calculated, using the raw I-V data and the active area of the fuel cell. Cells were tested up to 90 hours to evaluate their I-V performance over time and determine if there was any degradation in cell performance. Repeatability and reproducibility was determined by measuring the cell performance on up to three different cells of the same configuration.

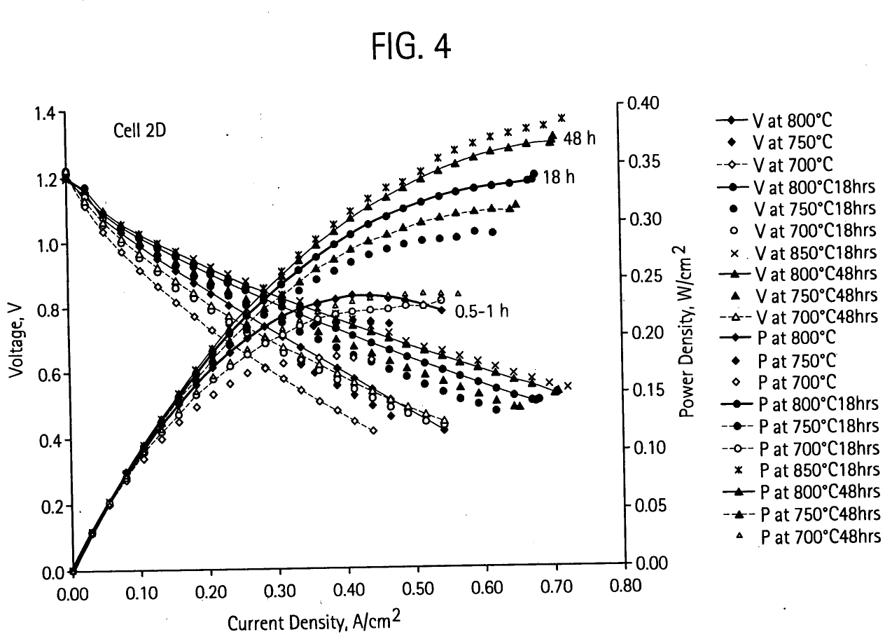

FIG. 4 is a plot of voltage (V) and power density in milliwatts/square centimeter (mW/cm²) versus current density in amperes/square centimeter (A/cm²) for Sample 2, with an open circuit voltage (OCV) close to 1.2 V, indicating a good gastight electrolyte seal. The cell performance was observed to increase over time. A reproducible amount of power of 2.5 to 3 watts per cell, with an electrolyte tube having a wall thickness of 0.55 millimeter was obtained. A maximum power density of 350 mW/cm² was obtained for the electrolyte tube having a wall thickness of 0.55 millimeter while for the electrolyte tube having a wall thickness of 0.22 millimeter a much higher maximum power density of 482 mW/cm² was obtained.

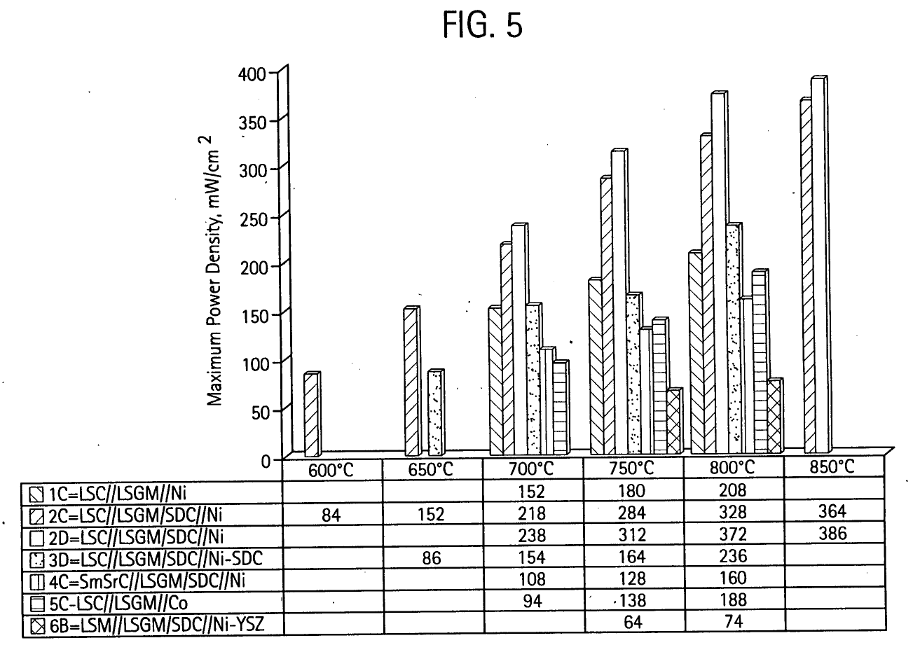

The overall cell performances for each of samples 1-6 are compared and illustrated in the bar plot in FIG. 5 for fuel cells having a thickness of 0.55 millimeters. From the figure it may be seen that the power density is greatest for Sample 2, having a LSCo cathode, a nickel anode and an interlayer. The power density for two specimens of Sample 2 (Sample 2C and 2D) are plotted to depict variations in a given sample. While there is a small variation of about 10% in the powder density measured for samples 2C and 2D, the results are generally consistent i.e., all of the samples show an increase in maximum power density with increasing temperature. The variation seen between the Samples 1-6 for a given temperature shows that the materials chosen for the anode, cathode and interlayer of the fuel cell can make a difference in the maximum powder density of the cell. For example, in comparing Sample 2 with Sample 4 and Sample 6, it can be clearly seen that fuel cells having a cathode derived from lanthanum-strontium-cobalt (LSCO) performs better than fuel cells having cathodes made from samarium-strontium-cobalt (SₘSᵣCo) or cathodes made from lanthanum-strontium-magnesium (LSM). Without being limited by theory, the poor performance of the fuel cell containing the LSM cathode as compared with the cell containing the LSCo cathode is believed to be due to its high oxygen reduction over potential at low temperatures. As may be seen from FIG. 5, when comparing Sample 1 with Sample 5, the cells having a nickel anode performed better than those having the cobalt anode at 800° C. Similarly, the effect of the interlayer at a temperature of 800° C. may also be seen in FIG. 5, where a comparison between Sample 1 and Sample 2 clearly shows that the presence of the interlayer in Sample 2 prevents the formation of an electrically resistive layer of La₂NiO₄ thereby increasing the maximum power density.

### EXAMPLE 2

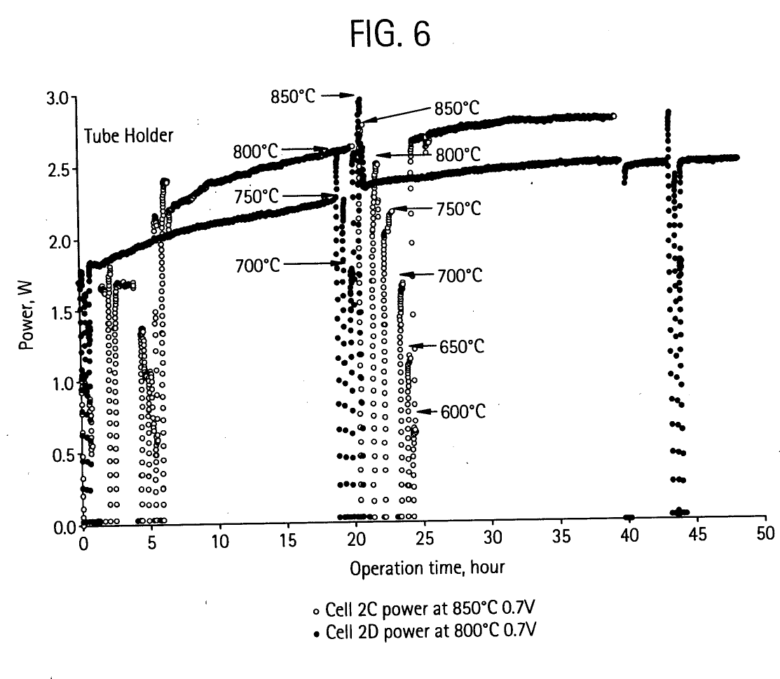

This test was undertaken to determine the solid oxide fuel cell stability and performance at different temperatures. Two cells having the composition of Sample 2 (i.e., Sample 2C and 2D respectively) were run separately for about two days at 800° C. and 850° C., respectively, at a loading of 0.7 V. FIG. 6 is a plot depicting fuel cell performance stability over time and at the different temperatures. It is clear that the performance of these two cells shows similar trends, i.e., power increased by approximately 17 to 18% during the first day and approximately 5 to 6% over the second day. The stable power outputs were 2.5 W for Sample 2D at 800° C., and 2.8 W for Sample 2C at 850° C., respectively.

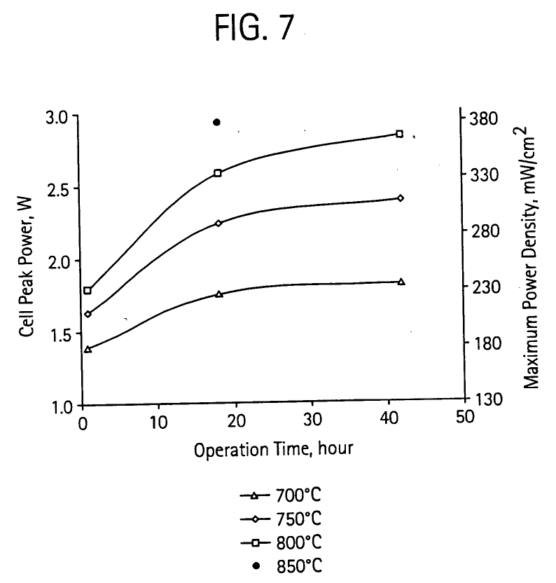

FIG. 7 further illustrates the effects of time and temperature of cell operation on the cell performance for Sample 2D. After running for one day, the maximum power density tended to be stable especially at the lower test temperatures.

### EXAMPLE 3

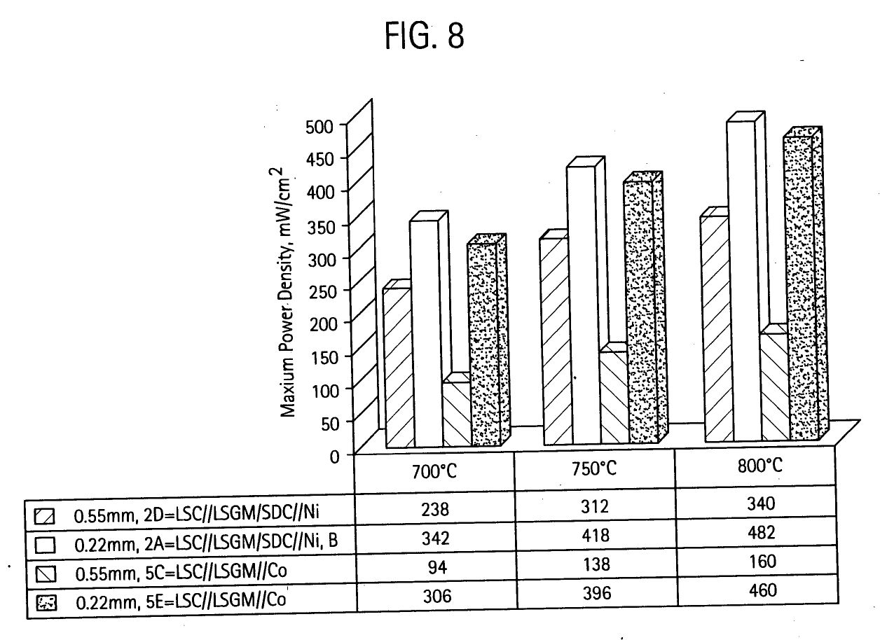

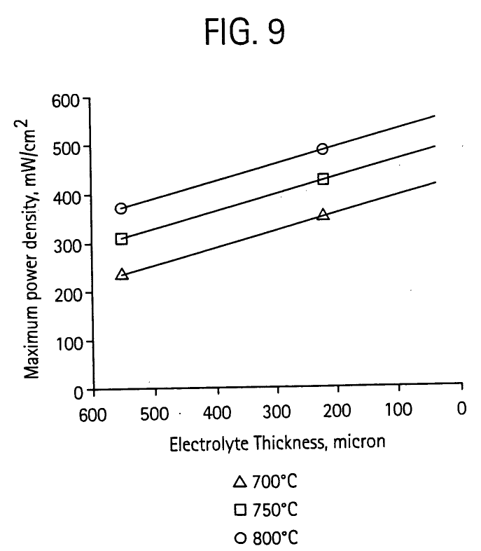

This experiment was conducted to determine the effect of the electrolyte tube thickness on the fuel cell power density. As detailed above, the electrolyte tubes were extruded with wall thicknesses of 0.55 millimeter (550 micrometers) and 0.22 millimeter (220 micrometers) respectively. FIG. 8 is a bar graph which reflects the power density performance of Sample 2 (Sample 2D having a wall thickness of 0.55 millimeter and Sample 2A having a wall thickness of 0.22 millimeter respectively) and Sample 5 (Sample 5C having a wall thickness of 0.55 millimeter and Sample 5E having a wall thickness of 0.22 millimeter) from Table 2 above at temperatures of 700° C., 750° C. and 800° C. Similarly FIG. 9 is a linear plot of the power density performance at different electrolyte thickness for Sample 2 (Sample 2A and 2D respectively). From both FIGS. 8 and 9 it may clearly be seen that as the wall thickness of the electrolyte tube is reduced, the maximum power density is increased. The maximum powder density is generally increased in an amount of about 34 to about 43% for a wall thickness reduction of over 50% when the wall thickness is reduced from 0.55 millimeters.

The solid oxide fuel cell obtained from the sintered electrolyte tube has a number of advantages as demonstrated in the above examples. At temperatures of about 700 to about 850° C., the fuel cell is capable of developing a maximum power density greater than or equal to about 300 mW/cm², preferably greater than or equal to about 350 mW/cm², more preferably greater than or equal to about 400 mW/cm², and most preferably greater than or equal to about 450 mW/cm² at a wall thickness of less than or equal to about 0.55 millimeters, preferably less than or equal to about 0.30 millimeters when subjected to a open circuit voltage of about 1.2 volts. The solid oxide fuel cell can also maintain its outer diameter and wall thickness within a tolerance of less than or equal to about ±0.2 millimeters, preferably less than or equal to about ±0.1 millimeters, and more preferably about ±0.05 millimeter during sintering at temperatures of greater than or equal to about 700° C., preferably greater than or equal to about 900° C., and more preferably greater than or equal to about 1100° C. as well as during operation at elevated temperatures of about 600° C. to about 900° C.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of manufacturing a green electrolyte tube comprising:
forming a composition comprising lanthanum-strontium-gallium-magnesium oxide powder and a binder into a green electrolyte tube, wherein the outer diameter of the green electrolyte tube has a tolerance of less than or equal to about ±0.3 millimeters over a tube length of greater than or equal to about 5 millimeters, and the wall thickness of the green electrolyte tube has a tolerance of less than or equal to about ±0.2 millimeters over a length of greater than or equal to about 5 millimeters.

2. The method of claim 1, wherein the forming is accomplished by extrusion.

3. The method of claim 1, wherein the forming is accomplished by mixing the composition into a dough and extruding the dough.

4. The method of claim 3, wherein the dough is mixed in a sigma blade mixer, a helicone, a roll mill, a Ross mixer, a dough mixer, a Waring blender, a Henschel, screw extruder, twin screw extruder, buss kneader or combinations comprising at least one of the foregoing mixing devices.

5. The method of claim 1, further comprising sintering the green electrolyte tube to form a sintered electrolyte tube, wherein the outer diameter of the sintered electrolyte tube has a tolerance of less than or equal to about ±0.3 millimeters over a tube length of greater than or equal to about 5 millimeters, and the wall thickness of the sintered electrolyte tube has a tolerance of less than or equal to about ±0.2 millimeters over a length of greater than or equal to about 5 millimeters.

6. The method of claim 1, wherein the lanthanum-strontium-gallium-magnesium oxide powder has an average particle size of less than 1 micrometer, and is used in an amount of about 60 wt % to about 95 wt % based on the total weight of the composition.

7. The method of claim 1, further comprising a lubricant, wherein the lubricant is polyethylene glycol and is used in an amount of 0.5 wt % to about 2.5 wt % based on the total weight of the composition.

8. The method of claim 1, further comprising a pH control agent, wherein the pH control agent is 2-amino-2-methyl-1-propanol and is used in an amount of 0.5 wt % to about 3.5 wt % based on the total weight of the composition.

9. The method of claim 1, further comprising a binder, wherein the binder is an acrylic based polymer or a polyether, and wherein the binder is used in an amount of 8 wt % to about 25 wt % based on the total weight of the composition.

10. The method of claim 2, wherein the extrusion is carried out in a single screw extruder, twin screw extruder, ram extruder, buss kneader, injection molding machine, blow molding machine, vacuum forming machine and wherein the input energy during extrusion is about 1 to about 3 kilowatt-hour/kilogram.

11. The method of claim 3, wherein the mixing is accomplished by using an energy input of about 0.5 to about 2 kilowatt-hour/kilogram.

12. The method of claim 3, further comprising applying a vacuum of about 5 to about 700 millimeters of mercury during the mixing.

13. The method of claim 1, wherein the outer diameter of the green electrolyte tube has a tolerance of less than or equal to about ±0.2 millimeters over a tube length of greater than or equal to about 5 millimeters, and the wall thickness of the green electrolyte tube has a tolerance of less than or equal to about ±0.15 millimeters over a length of greater than or equal to about 5 millimeters.

14. The method of claim 1, further comprising drying the green electrolyte tube in air, or moving air prior to sintering.

15. The method of claim 14, wherein the drying is accomplished in a tube holder having two blocks disposed upon one another, wherein each block has a semi-cylinder cut out of it and further wherein an inner diameter formed when the two blocks are disposed upon each other is greater than or equal to an outer diameter of the green electrolyte tube.

16. The method of claim 5, wherein the sintering of the green electrolyte tube is accomplished in a V-shaped sample holder, a semi-cylindrical sample holder, a semi-elliptical sample holder or combinations comprising at least one of the foregoing sample holders and wherein each green electrolyte tube is disposed between two tubes.

17. The method of claim 5, wherein the green electrolyte tube is sintered for about 4 to about 8 hours at a temperature of about 1350 to about 1600° C.

18. A solid oxide device comprising the green extruded electrolyte tube manufactured by the method of claim 1.

19. A solid oxide device comprising the sintered electrolyte tube manufactured by the method of claim 5.

20. A method of manufacturing a solid oxide fuel cell comprising:
extruding a composition comprising lanthanum-strontium-gallium-magnesium oxide powder, a binder, a lubricant, a solvent and a pH control agent into a green electrolyte tube;
sintering the green electrolyte tube to form a sintered electrolyte tube, wherein the outer diameter of the sintered electrolyte tube has a tolerance of less than or equal to about ±0.3 millimeter over a tube length of greater than or equal to about 5 millimeters, and wall thickness of the sintered electrolyte tube has a tolerance of less than or equal to about ±0.2 millimeter over a tube length of greater than or equal to about 5 millimeters; and
disposing upon the sintered electrolyte tube an anode and a cathode.

21. The method of claim 20, wherein the lanthanum-strontium-gallium-magnesium oxide powder has an average particle size of less than 1 micrometer, and is used in an amount of about 60 wt % to about 95 wt % based on the total weight of the composition.

22. The method of claim 20, wherein the lubricant is polyethylene glycol and is used in an amount of 0.5 wt % to about 2.5 wt % based on the total weight of the composition and wherein the pH control agent is 2-amino-2-methyl-1-propanol and is used in an amount of 0.5 wt % to about 3.5 wt % based on the total weight of the composition.

23. The method of claim 20, wherein the extrusion is carried out in a single screw extruder, twin screw extruder, ram extruder, buss kneader, injection molding machine, blow molding machine, vacuum forming machine, and wherein the input energy during extrusion is about 1 to about 3 kilowatt-hour/kilogram.

24. The method of claim 20, further comprising mixing the lanthanum-strontium-gallium-magnesium oxide powder, a binder, a lubricant and a pH control agent in a mixer under a vacuum of about 5 to about 700 millimeters of mercury prior to extrusion wherein the energy input during mixing is about 0.5 to about 2 kilowatt-hour/kilogram.

25. The method of claim 20, wherein the extruded tube has a variation in outer diameter of about 2 millimeters to about 10 millimeter and a variation in wall thickness of about 0.1 millimeters to about 1 millimeter.

26. The method of claim 20, further comprising drying the green electrolyte tube in air, or moving air prior to sintering.

27. The method of claim 20, wherein the green electrolyte tube is sintered for about 4 to about 8 hours at a temperature of about 1350 to about 1600° C.

28. The method of claim 20, further comprising drying the green electrolyte tube, wherein the drying is accomplished in a tube holder having two blocks disposed upon one another, wherein each block has a semi-cylinder cut out of it and further wherein an inner diameter formed when the two blocks are disposed upon each other is greater than or equal to an outer diameter of the green electrolyte tube.

29. The method of claim 20, wherein the sintering of the green electrolyte tube is accomplished in a V-shaped sample holder, a semi-cylindrical sample holder, a semi-elliptical sample holder or combinations comprising at least one of the foregoing sample holders and wherein each green electrolyte tube is disposed between two tubes.

30. The method of claim 20, wherein the anode is derived from nickel oxide, cobalt oxide, nickel oxide with yttrium stabilized zirconia, nickel oxide with samarium doped ceria or combinations comprising at least one of the foregoing oxides and has a thickness of about 10 to about 30 micrometers.

31. The method of claim 20, wherein the cathode is derived from lanthanum-strontium cobalt, samarium-strontium-cobalt, samarium-strontium-cobalt oxide or combinations comprising at least one of the foregoing ceramic powders and has a thickness of about 20 to about 30 micrometers.

32. The method of claim 20, further comprising disposing an interlayer on the sintered electrolyte tube, wherein the interlayer is derived from samarium doped ceria and has a thickness of about 10 to about 15 micrometers.

33. The method of claim 20, wherein the solid oxide fuel cell has a maximum power density of greater than or equal to about 450 milliwatt/square centimeter at a wall thickness of less than or equal to about 0.3 millimeter, when subjected to an open circuit voltage of 1.2 volts.

34. A solid oxide fuel cell manufactured by the method of claim 20.
